(19) United States
(12) Patent Application Publication
(10) Pub. No.: US 2002/0128872 A1
(43) Pub. Date: Sep. 12, 2002

(54) Medical data recordation system

(76) Inventor: Charles P. Giammattei, Swarthmore, PA (US)

Correspondence Address: PEPPER HAMILTON LLP, 50th Floor, One Mellon Center, Pittsburgh, PA, 15219, US

(21) Appl. No.: 10/068,764

(22) Filed: Feb. 5, 2002

Related U.S. Application Data
(60) Provisional application No. 60/266,521, filed on Feb. 5, 2001.
(60) Provisional application No. 60/223,650, filed on Aug. 7, 2000.

(51) Int. Cl. G06F 17/60

(52) U.S. Cl. 705/3

(57) ABSTRACT

A portable data collection system is described for the statistical collection of patient medical data that is useful to track medical outcomes. The system provides a means to determine medical outcomes by combining patient and physician input collected by handheld equipment. The data is transmitted to a central location. Patient medical outcomes can be readily recorded and observed without manual re-entry of collected data.

### PRIORITY

This application claims priority to the provisional U.S. patent application entitled PDA Medical Data Recordation System, filed Feb. 5, 2001, having a Serial No. 60/266,521, which is hereby incorporated by reference in its entirety.

### FIELD OF THE INVENTION

The present invention generally relates to methods and systems for the collection of medical data regarding patient history. More particularly, the invention relates to a method and system for collecting medical data and other information that is useful to track patient medical outcomes, thus reducing or eliminating the need for manual data entry from a conventional pen and paper input form.

### BACKGROUND OF THE INVENTION

Presently, in many medical practices, medical information is collected by manual data entry into forms. For example, in the practice of orthopedic medicine, forms known as the SF-36 Health Survey, the WOMAC Protocol, the Knee Society Evaluation Form, and the Harris Hip Survey are often used to collect information from patients by hand. The information collected may include patient background information, patient health, and history related to very specific activities of the patient. The information is then used to determine overall patient's improvements, if any.

The existing methods of gathering and maintaining such information are time-consuming and labor-intensive. Most frequently, such information is collected using a clipboard and a pencil whereby the patient is asked to fill out (or a medical assistant fills out) a variety of standardized forms that ask various questions realting to, for example, the patient's medical history, pain management, daily life activities, and/or other indicators. The information that is manually entered on the forms is then often entered into a computing device to provide for storage and retrieval at a later time.

The existing methods result in several disadvantages. Manual collection of data provides no means to easily and immediately compare the data to previous data for that patient and/or for other patients. In addition, files must be searched by hand, or the data must be manually entered into a computing device at a later point in time, in order to track the progress of various outcomes. Further, if the patient or medical assistant who collects the information does not write clearly, the information may not be able to be retrieved or understood in the future.

Accordingly, it is desirable to provide an improved method and system for collecting patient medical information for the recording and observing of patient medical outcomes.

### SUMMARY OF THE INVENTION

Accordingly, it is an object of the present invention to provide an improved method and system for collecting patient medical information for the recording and observing of patient medical outcomes.

It is yet a further object of the present invention to provide a means for collecting standardized patient medical background history and related information in a small portable computing device, and to synchronize such medical data with a selected computing device that compiles and maintains such patient information, and which may convey such information to a central data processing and/or storage system.

The above and other features and advantages are achieved through the use of a novel patient data collection system and method as herein disclosed. In accordance with a preferred embodiment of the present invention, the invention provides a medical data collection system that avoids the undesirable aspects of repetition of data entry, as well as errors and delays in data input reproduction. In accordance with a preferred embodiment, a small, portable computing device, such as a personal digital assistant (PDA), is programmed to emulate one or more information capture protocols for a given field of the practice of medicine. In the preferred embodiment, the system is programmed to emulate certain protocols in the field of orthopedic medicine, although the invention, when programmed with appropriate input protocols, may be used in other medical fields as well.

The advantages of having patient information and history compiled into an electronic data processing format can be appreciated in that such information can be much more easily processed, reviewed, and analyzed once the information is collected in electronic format. Accordingly, the present invention provides a method and system for collecting patient medical information in a screen by screen presentation on a small, portable computing device such as a PDA. The device requests information, preferably via the display of the computing device, and prompts the user to tap the device's two-way touch screen or otherwise enter the information in response to particular questions regarding both the patient's background and the health related questionnaires presented.

Since computing devices such as PDAs frequently provide infrared data ports which allow two-way “beaming” of information through infrared transmission to and from the PDA, information may be collected by a given PDA that is programmed to present the questions in a preferred fashion. However, other information transmission mechanisms, such as wireless transmissions, wired links, and global information networks such as the Internet may also be used.

There have thus been outlined the more important features of the invention in order that the detailed description that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating a patient information form collection architecture utilized in a preferred embodiment, with an exemplary data protocol that would be appropriate for an orthopedic practice.

FIG. 2 is a block diagram of the physician data input form architecture utilized in the preferred embodiment.

FIG. 3 is a block diagram of the patient data base architecture utilized in the preferred embodiment.

FIG. 4 is a block diagram of the physician data base architecture utilized in the preferred embodiment.

FIG. 5 is a block diagram illustrating the interconnection of the equipment components used to practice the present invention.

FIG. 6 illustrates actions that may be taken to use the embodiment of FIG. 5

### DETAILED DESCRIPTION OF PREFERRED EMBODIMENTS OF THE INVENTION

The invention provides an improved medical data collection system. In the preferred embodiment, the system is programmed to emulate certain protocols in the field of orthopedic medicine.

Presently, certain medical information that is useful for tracking patient outcomes is collected by manual data entry into paper forms. For example, in the field of orthopedic medicine, such forms are known widely as the SF-36 Health Survey, the WOMAC Osteoarthritis Index, the Harris Hip Evaluation Form, and the Knee Society Survey. The information collected can be used by the physician to determine the patient's overall improvements, if any, or the effectiveness of any medical procedures. Such information therefore helps the physician track medical outcomes.

Accordingly, the present invention provides a method and system for collecting patient medical information in a screen by screen presentation useable on a small, portable computing device such as a PDA. In a preferred embodiment, the computing device uses the popular Palm™ operating system, although devices with other operating systems may be used. The device requests information via the display of the computing device and prompts the user to tap the device's two-way touch screen or otherwise enter the information in response to particular questions regarding both the patient's background and the health related questionnaires presented.

Since computing devices such as PDAs frequently provide infrared data ports that allow two-way “beaming” of information through infrared transmission to and from the PDA, information may be collected by a given PDA that programmed to present the questions in a preferred fashion. Thus, the device may collect information locally in its operating system, and then pass the information to a designated central PDA or other computing device such as a central server. The central computing device acts as a collection point to synchronize and thereafter download all such information that it may receive from the PDA and/or from other PDAs to a main computer. Other transmission mechanisms, such as direct communications links, wireless transmissions, and the Internet may be used. The patient information can then be compiled and used to evaluate various treatment mechanisms, physiological functions, responses, and outcomes of patients. Similar data may be collected for various medical disciplines.

Referring now to the drawings in more detail, the invention will be described in terms of its operation in the preferred embodiment. The present invention provides a data collection system that includes the use of one or more small computing devices, such as PDAs which are widely produced and now commonly available. Any standard device made by any of a variety of manufacturers such as Palm, Handspring, Sony, Blackberry, Hewlett-Packard, Compaq, and others may be used, as each uses an operating system that allows for programmability. The invention may also be used with other portable computers, such as laptop or Palmtop computers and other similar portable data collection and processing equipment.

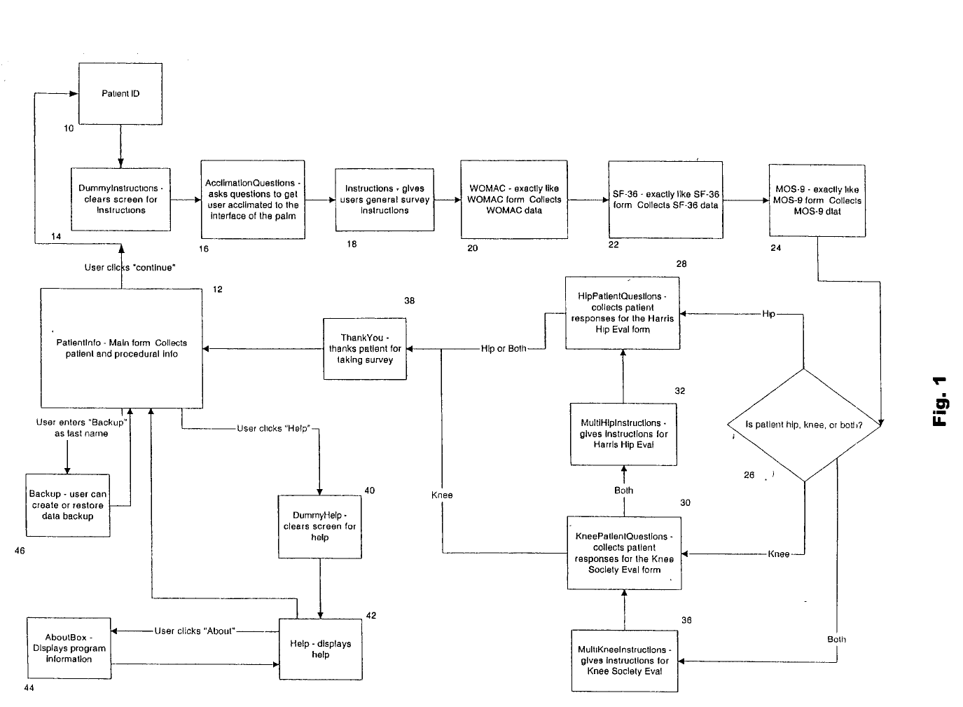

Referring to FIG. 1, a block diagram of the patient data input form architecture used in the present invention is described in terms of function. In a preferred embodiment, as applied in the field of orthopedic medicine, the patient is handed a PDA or other computing device with a question protocol as described in FIG. 1. The description below describes data entry by the patient. In a preferred embodiment, the patient information will be entered (step 12) by a patient who is handed the device by medical staff or other assistants, so that the patient can navigate through the questions presented on the face of the device. In this fashion, the patient can enter data directly in digital form, which ultimately can be transferred from the PDA or other collection device to a more central data collection system. Optionally, however, the information may be entered by a medical assistant or other member of the medical practice's staff. A patient ID is established (step 10) for each patient so that all records accumulated may be referenced to the particular individual. A patient ID may be, for example, a social security number, a last name and/or a date of birth, or some other indicator to ensure accurate correlation of collected patient data with an individual patient.

In initiating the form data entry, the patient may be prompted to click “continue” or enter some other action, or the patient may be automatically moved to an action (step 14) that clears the screen for further instructions. Preferably, one or more basic questions are asked to allow the user to become accustomed with the interface used in a personal digital assistant (step 16). Most instructions can be requests such as “tap here” or “tap arrow to proceed”. Such questions can provide a comfort level for those users who are not familiar with touch screens or similar user interfaces. Next, the user may receive general instructions (step 18) that provide the user with information about how to use the survey.

The invention then goes on to present screens or otherwise request historical information from the patient (step 20). In the case of an orthopedic practice, this information may include, for example, a request that the patient identify (i) when pain and/or stiffness typically occurs; (ii) the typical severity of pain and/or stiffness; (iii) physical activities for which the patient experiences difficulty. Preferably, this information is collected in accordance with the WOMAC Osteoarthritis Index protocol. The information may provide an evaluation from a patient's perspective of observations, conditions, or other medical complaints or comments.

The patient then moves on to step 22, where additional patient information relating to the patient's health can be collected. In the embodiment relating to an orthopedic practice, this information may include, for example, requests that the patient generally describe his or her health, comparison of current health with previous health, activities that are limited or interfered with because of the person's health or physical condition, and general emotional and/or physical well-being. Preferably, this information is collected in a multiple choice format using a protocol most commonly known as the SF-36 Health Survey. Once again, the patient moves through the form information by reading each question presented on the screen of a collection device such as a PDA. The patient enters his or her response into the device, preferably in a fashion similar to how a response would be entered using answers offered in a multiple choice or “yes/no” check box format on a conventional piece of paper. In the preferred embodiment, the patient also moves on to step 24, where the device collects data relating to the patient's satisfaction with the physician's medical and/or office staff (e.g., wait time satisfaction, customer friendliness, staff competence, and convenience), such as that presented when using the MOS-9 Survey protocol that is frequently used in an orthopedic practice.

In an orthopedic medical practice, in the inquiry and data collection step (step 12) typically asks the patient to indicate whether his or her present condition involves a medical problem with a hip, knee, or both. Optionally, other body parts may also be included in the prompt. Based on the results of this input, the system then determines which series of additional questions to present to the patient (step 26).

As can be appreciated by the flow chart in FIG. 1, the response to the question or questions at step 26 will give rise to different actions and prompts for the collection of information. If the patient's problem is with the hip, the patient is prompted to enter specific information relating to hip injuries (step 28). Preferably, information such as that found in the Harris Hip Evaluation Form may be used.

If the patient's problem is with a knee, the patient is prompted to enter specific information relating to knee injuries (step 30). Preferably, information such as that found in the Knee Society Evaluation Form may be used. Such information may include, for example, information relating to the patient's pain, stability, mobility range, activity range, and/or ability to function, as well as the patient's satisfaction with the procedure.

If the answer to the inquiry at step 26 is that the patient's condition involves both hip and knee, the patient may be given multi-knee instructions (step 36) and multi-hip instructions (step 32) before each type of information is collected.

After the patient navigates through the knee and/or hip questions, optionally the patient is thanked (step 38) or otherwise acknowledged as the device saves the information. Optionally, the system may automatically present a new patient information form so that the next user can begin responding to the questionnaire (step 12).

FIG. 1 also illustrates preferred, although optional, steps to allow a user to back up data (step 46), display program information such as version or updates (step 44), and clear the screen to place the device into a help display (step 40) and/or a help function (step 42). These steps are preferably be accessed by selecting program paths available from the main screen (presented in step 12).

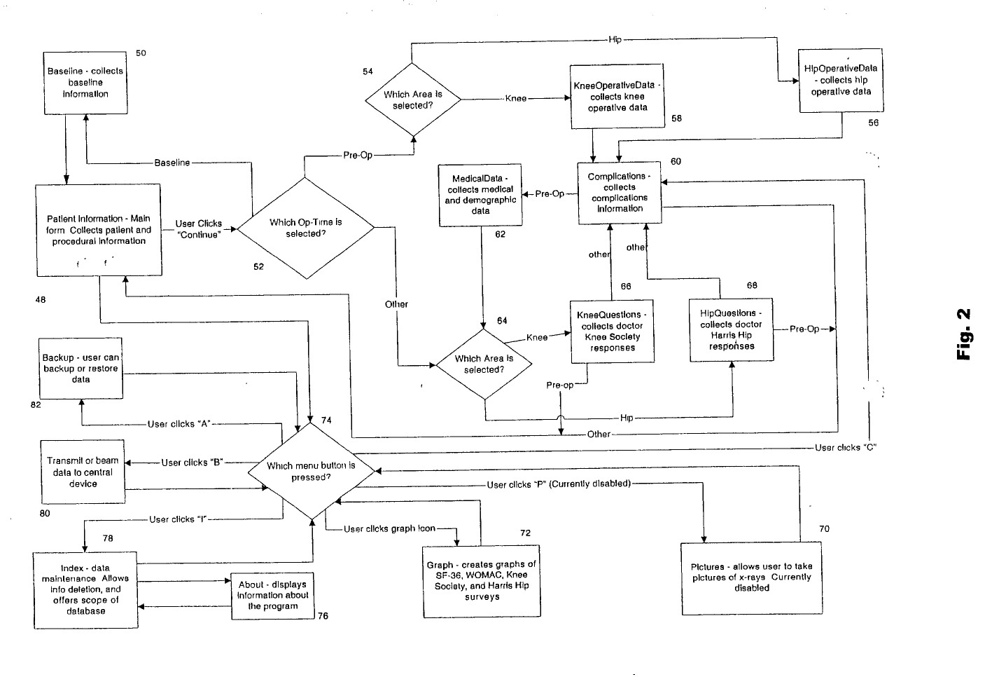

FIG. 2 illustrates a preferred physician input sequence process flow, which in this illustration is for an orthopedic practice. Referring to FIG. 2, an opening screen is preferably presented (step 48) for the physician on a programmed PDA or other data collection device. On this screen, the physician will identify the particular patient, as well as additional information relating to the patient's condition, such as body area (i.e., hip or knee) and operation time.

Preferably after a prompt, such as by clicking “continue”, the system then moves to an area for the collection of appropriate information based on the patient's condition and/or operating time. For example, the system may proceed along a baseline, pre-operative, and/or post-operative line of questioning. The doctor may elect to enter, or the system may request, baseline information (step 50). The baseline information may include, for example, a referral identification and background about the patient's condition (i.e., chronic or acute, such as with injury-causing incident). Optionally after a prompt (such as to click “continue”), the system then moves to an area for the collection of appropriate information, based on the patient's condition and/or operation time. For example, the system may determine whether to proceed along a pre-operation path or another (i.e., post-operation) path (step 52). The system will then proceed along an appropriate information collection path, depending on the operation time.

If the patient is in a pre-operative stage, the system determines (based on previously-entered information) whether it is a knee, hip, or optionally other operation that is being undertaken for the patient (step 54). If a hip operation, the system collects hip operative data about the individual patient (step 56). Such information may include, for example, a diagnosis and/or procedure, as well as a description of the planned medical procedure and/or discharge treatments. The information may be entered by the physician and/or be derived from the information previously entered by or on behalf of the patient.

If a knee operation, the system collects knee operative data about the individual patient (step 58). Again, such information may include, for example, a diagnosis and/or procedure, as well as a description of the planned medical procedure and/or discharge treatments. Also, such information may be entered by the physician and/or be derived from the information previously entered by or on behalf of the patient.

In either case, after the operative data is entered and/or reviewed, the physician may then enter complication information (step 62), such as whether the patient is experiencing healing issues or other complications.

Whether arriving from step 56 or 58, step 60, the device may also present the doctor with a medical data and demographic data screen (step 62). This screen asks the doctor to enter general information that is of interest to the measurement of patient outcomes, but which are not necessarily directly associated with the particular procedure. Such information may include, for example, pre-existing conditions (diabetes, heart disease, etc.), whether the patient is a smoker, and other factors. Optionally, the order of steps 60 and 62 may be reversed. In fact, step 60 can be inserted at almost any step of the process, and all or part of the information requested in step 60 may optionally be entered by or on behalf of the patient.

Referring again to decision box 52, if the patient is at a post-operation stage (or any stage other than a baseline stage), the system determines (based on previously-entered information) whether the patient's knee or hip is of interest (step 64). Optionally, other areas may be considered as well. If the knee is identified in step 64, the system asks the physician or patient to respond to various questions relating to the knee, preferably in accordance with the Knee Society protocol (step 66). Such questions may request, for example, information relating to the patient's pain, stability, mobility range, activity range, and/or ability to function.

If the hip is identified in step 64, the system asks the physician or patient to respond to various questions relating to the hip, preferably in accordance with the Harris Hip protocol (step 68). Such questions may include, for example, information relating to the patient's pain, ability to function and/or walk, difficulties with physical activities, and/or deformities.

From either point, if the patient is in a post-operative stage the operator can then be asked to enter complications (step 60), such as whether the patient is experiencing healing issues or other complications. The operator may also return to main patient information screen (step 48). The responses collected in steps 60, 66 and 68 may be collected again at a later date, such as six months after the surgery or one year after the surgery, to allow the physician to track the patient's progress and outcomes.

From the main patient information input area (step 48), FIG. 2 illustrates that additional options are preferably available. The system determines whether to present any of these additional options depending upon data entered or menu items selected by the user (step 74). For example, the physician may elect to proceed directly to the complications step (step 60) from the main form. Other options may include one or all of the following, among others: backup and/or restoration of data (step 82), transmission of information (as with an infrared port commonly available on portable hand held computer devices, and/or through synchronization, wireless transmission, or otherwise) (step 80), and indexing and/or data maintenance page (step 78). Information regarding the status of the program, including the version, license information and other data can be displayed (step 76).

Preferably, the user may also request one or more graphing functions for creating graphs of data entered by the patient, physician, and/or others. Such graphs may include graphs of the data entered by the patient and/or physician, thus providing a visual representation of improvement (or lack thereof), as well as the ability to compare patient-specific data with expected, average, or other baseline data (step 72). Using the built in arithmetic and calculation functions of PDAs, such as those found in the Palm™ operating system, presentation of such graph information can be made even more straightforward by using built in math processing available with PDAs and other devices. Likewise, the device's operating system may provide for image output. Thus, in a preferred embodiment, x-rays and/or other medical imaging data for a particular patient can be presented (step 70) to allow storage of such patient information to the extent that the device being used has sufficient memory to accommodate the images which may be associated with a particular patient's record.

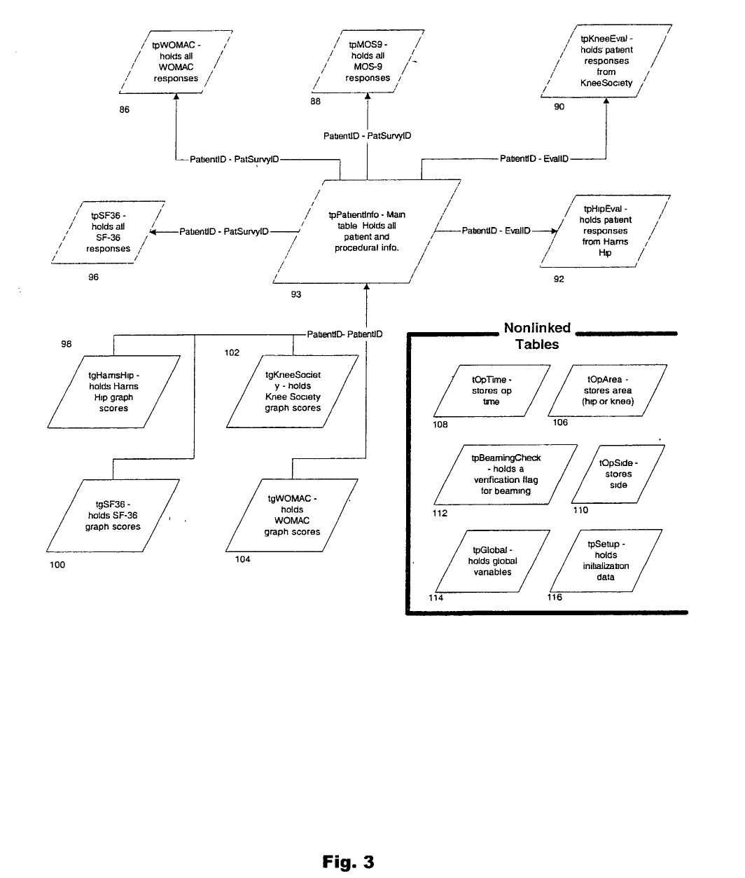

FIG. 3 illustrates a preferred patient database architecture for used with the present invention. The data contained in the patient database is preferably that which was entered in accordance with some or all of the steps illustrated in FIG. 1. In many protocols that determine patient medical outcomes, information may be derived from the patient's responses to a series of standardized questions. The actual questions selected depend on the particular field of medicine. FIG. 3 illustrates an example where the fields relate to orthopedic medicine. The fields describe the type of information requested, and the fields are linked to each other, preferably via a main tables 93 that holds patient identification and/or procedural information. The linked tables may include, for example, a table 86 that collects patient responses relating to pain, stiffness, and/or physical function (such as that found in a WOMAC questionnaire). Similarly, table 88 holds the staff and office satisfaction (such as MOS-9) responses, while table 90 will hold knee evaluation responses, such as that collected using the Knee Society protocol. Table 96 collects health survey (such as SF-36) responses, while table 92 collects responses from a patient if the patient or patient's physician has responded to a hip evaluation (such as a Harris Hip survey) on the screen of the PDA.

In all cases it can be seen that the patient ID (item 10 in FIG. 1) may be used to compare the patient with the particular procedures entered for that patient as earlier described, thereby enabling those data fields 86, 88, 90, 92 and 96 as may be relevant for that particular patient at a given time. The data base architecture described in FIG. 3 also provides for collection of the information in order to graph the responses for use by a physician at a later point in time. For example, field 98 collects hip evaluation (e.g., Harris Hip) graph scores. Field 100 collects health survey (e.g., SF-36) graph scores. Field 102 collects knee evaluation (e.g., Knee Society) graph scores. Field 104 collects pain/stiffness/physical function (e.g., WOMAC) graph scores.

Preferably, the patient database architecture also has various non-linked tables that may be used to collect information relating to the patient and/or the patient's condition. Such tables can, but need not, interact with the other tables and data fields described in FIG. 3. Referring to FIG. 3, such non-linked tables may include, for example, a table that stores the operation time 108, a table that stores whether it is a hip or knee (or optionally other) operation that is contemplated 106, and/or a table that holds a verification checklist for beaming or otherwise transmitting data between devices 112. Table 110 holds operation side information (i.e., whether the operation must be performed on the left side or right side of the patient's body). Table 114 holds global variables. Finally, table 116 holds set-up information for initialization data upon boot of the application.

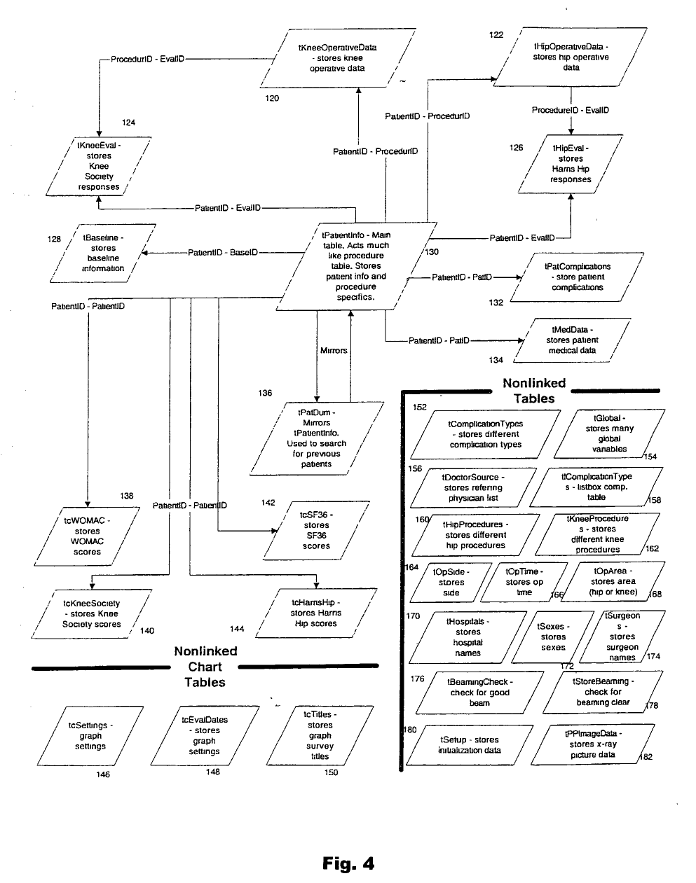

FIG. 4 illustrates a preferred architecture of the physician database used in the present invention. The physician database architecture is populated with information entered using a method such as that illustrated in FIG. 2 Referring to FIG. 4, a patient information table 130 is the central table used in the database. Table 130 acts much like a procedures table, storing patient information and procedure-specific information regarding the patient. Other tables are linked, preferably via the patient information table 130. A knee operative data table 120 stores knee operative information with references to a particular patient. Knee evaluation table 124 is used to store information (such as Knee Society responses) provided by the physician screen input in step 66 of the physician form architecture of FIG. 2. A baseline information table 128 stores the baseline information collected by the physician (in step 50 of FIG. 2). A WOMAC table 138 collects the information relating to patient pain/stiffness/physical function scores and/or information. A Knee Society data table 140 likewise collects the knee-related information entered by the physician. Table 142 collects information relative to health survey (SF-36) scores entered, while a hip table 144 stores information relating to hip evaluation (Harris Hip) scores.

As with the patient database structure, the physician database structure may include non-linked tables that may be are used to collect information relevant to the patient. Such tables can, but need not, interact with the other data fields described in FIG. 4. Referring to FIG. 4, such non-linked tables may include, for example, a table of complication types 152, a table of global variables 154, a referring physician table 156, a table storing a list of complications 158, a hip procedure table 160, a knee procedure table 162, tables storing body location 164, operating time 166, and body area 168. Such tables may also include a hospital identification table 170, patient sex (male or female) data 172, and/or a surgeon name table 174. Tables relating to beaming 176 and 178, initialization 180, and/or imaging 182 may also be provided.

Chart tables such as 146, 148, and 150 may also be provided to assist with graphic representations of the data.

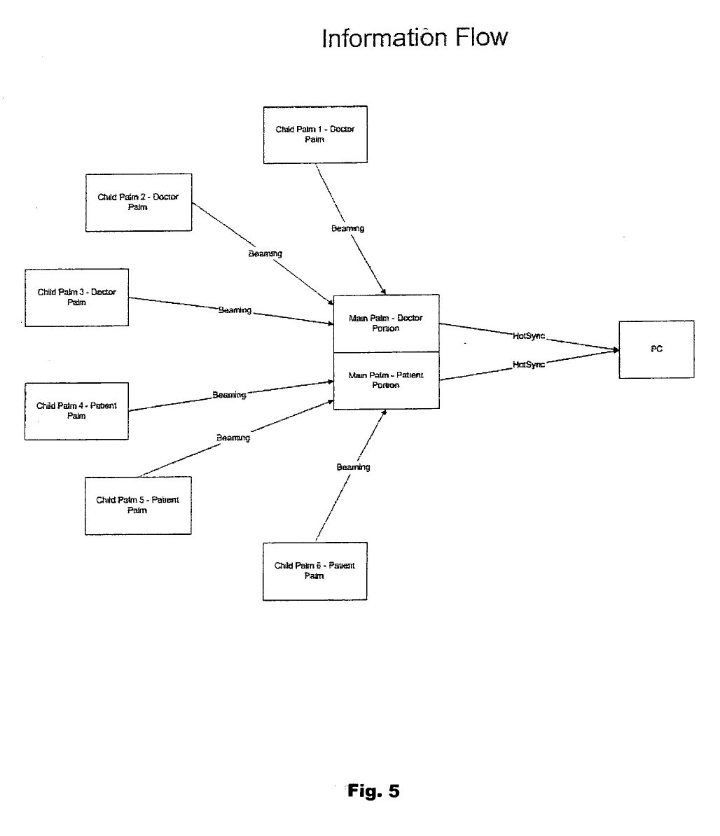

FIG. 5 illustrates that many portable devices may be linked to share and/or centrally collect information collected for multiple patients. Referring to FIG. 5, a plurality of remote information collection devices (such as Palm™ PDAs) 200, 202, 204, 206, 208, and 210 are available to collect information relating to multiple patients from patients, doctors, and/or others. The number of portable devices illustrated in FIG. 5 is only exemplary, and in fact any number of such devices may be used. The information may be transmitted to one or more central information collection devices 212 and 214, where the information may be processed and/or stored. The central information collection devices may also be PDAs or other portable collection units, or they may be a personal computing device, central server, or other device. In addition, although FIG. 5 illustrates an embodiment where two central programs or devices are used, one device and/or one program may optionally be used to collect information from both the doctor and the patient. Also, the communications links may be wireless links such as with a PDA beaming feature (as shown in FIG. 5), a digital or analog cellular or wireless Internet link. Alternatively, the links may be direct wires such as with a PDA synchronization cradle, a communications network link such as the Internet, or any other type of link.

Optionally, the central collection device or devices may further transmit the information to a central server or desktop computer 216. Again, the communications links may be wireless links such as a PDA beam, direct wires such as synchronization cradles, a communications network link such as the Internet, or any other type of link.

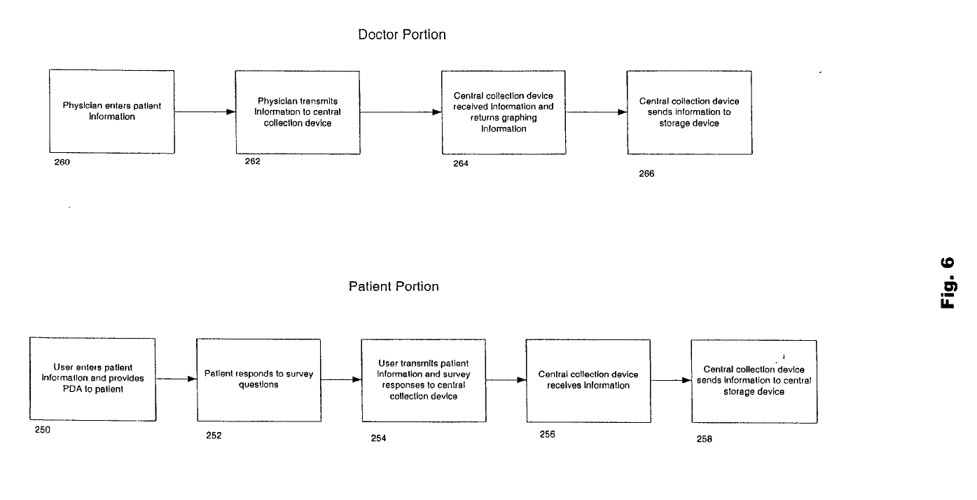

FIG. 6 illustrates actions that may be taken to use the embodiment of FIG. 5. For the patient, a nurse or assistant may give the collection device to the patient (step 250), and the patient (or someone on behalf of the patient) enters the patient's information into the device (step 256). The nurse, assistant, or other staff member then transmits the information collected by the device to a central collection unit (step 254) such as by beaming it to a main PDA. As described above in the text relating to FIG. 5, other central collection devices and communications paths may be used. Later, after the main PDA receives the information (step 256), the main PDA may transmit it to a central collection computer (step 258).

For the doctor, the doctor may enter patient information into the device (step 260), and when complete the doctor (or someone else) may transmit the information collected by the device to a central collection unit (step 262) such as by beaming it to a main PDA. As described above in the text relating to FIG. 5, other central collection devices and communications paths may be used. Later, the main PDA receives the information, and main PDA may return information, such as graphing information, to the doctor's device (step 264). The main PDA may also transmit the data to a central collection computer (step 266).

The many features and advantages of the invention are apparent from the detailed specification. Thus, the appended claims are intended to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

What is claimed is:

1. A data collection system, comprising a portable data information collection unit having a liquid crystal display capable of touch sensitive data input, wherein the data collection unit has data input and output ports to provide for data interchange between the unit and a personal computer, and wherein the unit is programmed to emulate a medical history data collection protocol.
